(19) United States
(12) Patent Application Publication
(10) Pub. No.: US 2010/0329258 A1
(43) Pub. Date: Dec. 30, 2010

(54) DYNAMICALLY ENABLING MPLS STATIONS AND PORTS USING AN ARP DATABASE

(75) Inventor: Gregory PAGE, Sandy, UT (US)

Correspondence Address: Terry W. Kramer, Esq.;Kramer & Amado, P.C., 1725 Duke Street, Suite 240, Alexandria, VA, 22314, US

(73) Assignee: ALCATEL-LUCENT USA INC., Murray Hill, NJ (US)

(21) Appl. No.: 12/495,383

(22) Filed: Jun. 30, 2009

(51) Int. Cl. H04L 12/56

(52) U.S. Cl. 370/392

(57) ABSTRACT

A method of dynamically enabling MPLS stations and ports using an ARP database is disclosed. The method of dynamically enabling MPLS stations and ports using an ARP database includes augmenting an ARP database with labels distributed via Label Distribution Protocol. The augmented ARP database includes for each ARP entry a list of labels that were advertised to an immediate neighbour. Subsequent use of the ARP database allows for automatic enabling/disabling of MPLS stations and allows labels to be used only on the appropriate ports as advertised to immediate neighbours. The method of dynamically enabling MPLS stations and ports using an ARP database is particularly useful for restricting ports and labels for security purposes, and to automatically provide configuration updates in a timely manner.

### FIELD OF THE INVENTION

This invention relates to Multi-Protocol Label Switching, and more particularly but not exclusively, to Multi-Protocol Label Switching stations and ports using an Address Resolution Protocol database.

### BACKGROUND OF THE INVENTION

This section introduces aspects that may be helpful in facilitating a better understanding of the invention. Accordingly, the statements of this section are to be read in this light and are not to be understood as admissions about what is in the prior art or what is not in the prior art.

In telecommunications Multi-Protocol Label Switching (MPLS) refers to a system and method for carrying data between telecom network equipment elements in a network. Such network equipment elements include, among other examples, routers and switches and in particular network equipment which performs the function of Label Edge Routing and Label Switch Routing.

Multi-Protocol Label Switching functionality is described comprehensively in the IETF technical documents RFC-3031 and RFC-3032. Multi-Protocol Label Switching can be conceived to operate as a protocol that lies between the OSI Model layers of Layer 2 (Data Link Layer) and Layer 3 (Network Layer). As such it acts to provide a unified data-carrying service that can carry many different kinds of traffic, including native ATM (Asynchronous Transfer Mode), SONET, and Ethernet frames, as well as IP packets.

Data packets in an MPLS network are prefixed with an MPLS header which contains one or more labels. This is called a label stack and is used to switch the associated data packet as it traverses the MPLS network instead of, for example, a lookup into an Internet Protocol (IP) routing table.

Packet entry and exit from an MPLS network occurs via Label Edge Routers (LERs) which push an MPLS label onto an incoming packet upon entry to the network, and pop the MPLS label off of the outgoing packet as it exits the network.

Within the MPLS network are routers which perform routing based only upon the MPLS label, and are denoted Label Switched Routers (LSRs). In some applications, the packet arriving at the LER may already possess an MPLS label, and in this case the LER may push a second label onto the packet.

Within the network, an LSR will advertise the labels that they know how to process to their immediate neighbors.

An LSR is responsible to:

1. Identify MPLS data packets that it should process. These frames have Medium Access Control (MAC) addresses, including VLANs where appropriate, that have been enabled on the switch as “MPLS Station Addresses”. Each MPLS Station Address is the MAC address of one or more network layer interfaces (for example, IP interfaces) on the switch.

2. Match the label(s) in the MPLS data packet to its own label database and, if found, process the data packet as described in that database. For security reasons, for example for avoiding Denial of Service (DoS) attacks, Multi Protocol Label Switching (MPLS) packets should only be accepted and processed when received on the minimum set of appropriate ports and addressed to the appropriate Medium Access Control (MAC) address.

The set of minimum appropriate ports should be a function of the specific MPLS label being processed. Switching Application Specific Integrated Circuits (ASICs) permit an enforcement of such a function. However, the set of appropriate ports may change over time due to network topological changes due to equipment changes or failures. For example, when the MAC address on a Network Interface Card (NIC) changes due to replacement of the circuit card upon which the NIC is located.

Commonly, MPLS Stations are currently enabled on either all network layer interfaces or manually specified on an interface by interface instance. Similarly, labels are accepted on all input ports and all MPLS Stations or are manually configured.

As is evident, allowing labels on all ports generates a security exposure. However, the alternative of manually establishing the appropriate set of labels to ports and MPLS Stations has drawbacks in that it incurs both time delay and upgrade operator labor costs until the manual upgrades can occur.

### SUMMARY OF THE INVENTION

An object of the present invention is to provide a dynamic method for enabling MPLS stations and ports using an ARP database.

According to an aspect of the present invention there is provided a method executed upon a network equipment element for automatically associating MPLS labels to MPLS station addresses, the method including the steps of establishing a database according to Address Resolution Protocol to associate network layer protocol addresses to data link layer addresses; advertising label binding information according to Label Distribution Protocol; augmenting the database to associate the labels to appropriate network layer protocol addresses; and processing received MPLS packets using the database.

Conveniently, the network layer protocol addresses may be an Internet Protocol address, and the data link layer addresses may be an Ethernet Media Access Control address.

Under certain embodiments the processing step includes abandoning MPLS packets which are not associated to appropriate network layer protocol addresses, while the augmentation step includes a list of labels advertised to a neighbour host in the MPLS network.

Advantages of the present invention include faster updating of labels to MPLS stations as compared to existing manual methods, and a reduced cost over manually applying updates.

In accordance with another aspect of the present invention there is provided an article of manufacture for use in programming a network equipment element to augment an ARP database by associating MPLS labels to appropriate network layer protocol addresses, the article of manufacture including computer useable media accessible to the network equipment element, wherein the computer useable media includes at least one computer program that is capable of causing the network equipment element to perform the steps of: establishing a database according to Address Resolution Protocol to associate network layer protocol addresses to data link layer addresses; advertising label binding information according to Label Distribution Protocol; augmenting the database to associate the MPLS labels to appropriate network layer protocol addresses; and processing received MPLS packets using the augmented database.

Under some embodiments, the network equipment element may be a Label Switched Router, and in other embodiments a Label Edge Router.

### BRIEF DESCRIPTION OF THE DRAWINGS

The present invention will be further understood from the following detailed description of embodiments of the invention, with reference to the drawings in which:

FIG. 1 illustrates a method for adding a label to an ARP database in accordance with the present invention; and

FIG. 2 illustrates a method for deleting a label from an ARP database in accordance with an embodiment of the present invention.

To facilitate understanding, identical reference numerals have been used, where possible, to designate identical elements that are common to the figures.

### DETAILED DESCRIPTION

In order to expedite the reconfiguration of LSR databases, it would be useful to provide an updating function which could automatically reconfigure labels to the Medium Access Control (MAC) addresses, including VLANs, which have been enabled on the switch as “MPLS Station Addresses”.

Under the MPLS protocol, an FEC is a representation of a group of packets that share the same requirements for their transport. At a Label Edge Router, once an incoming packet has been classified as a new or existing FEC, a label is assigned to the packet.

The labels are bound to an FEC as a result of some event or policy that indicates a need for such binding. These bindings can be either data-driven bindings or control-driven bindings.

Label Distribution Protocol (LDP) is a protocol which may be used for the distribution of label binding information to Label Switched Routers in an MPLS network. Under the protocol, Advertisement Messages are used to create, change, and delete label mappings for Forward Equivalency Classes (FEC).

Under LDP, when labels are advertised, the neighboring MPLS router's network interface layer address, typically the Internet Protocol (IP) address, becomes known. The known network interface layer address may be used as a basis for dynamically updating MPLS stations and ports associated with labels by using an Address Resolution Protocol (ARP) database as described in the following embodiment of the invention. The following description of an embodiment of the invention uses the example of ARP to dynamically update label associations between Internet Protocol network interface layer and an Ethernet layer. It is to be understood that as MPLS and ARP are able to be implemented upon many kinds of networks, that embodiments of the invention will be possible in these other networks.

In operation, the IP infrastructure has a database which uses the Address Resolution Protocol (ARP) database to map an IP address to the port, for example the MAC (Media Access Control) address, on which it is found. Similarly, the IP infrastructure's database includes a mapping of the IP interfaces on which packets from this IP address should be received.

According to an embodiment of this invention, this database can include triggers to enable and update the set of acceptable ports for a given label when modifications occur to the ARP entry. As well, triggers can be set to enable and disable the corresponding MAC addresses automatically as MPLS ingress Label Switched Paths (LSPs) are added and removed from the MPLS network.

The Address Resolution Protocol (ARP) is a network protocol which maps a network layer protocol address (for example an IP address) to a data link layer hardware address.

One of the more common uses is using ARP to resolve an IP address to the corresponding Ethernet (MAC) address. A host in an Ethernet network can communicate with another host only if it knows the Ethernet address of that host. As the length of a MAC address is 6 bytes and the length of an IP address is 4 bytes long, it is obvious that the MAC address cannot be represented using the IP address. This is the origin of the need for a mapping between the IP address and the corresponding MAC address.

ARP maintains the mapping between IP addresses and MAC addresses in a table in memory in a network equipment element called an ARP cache. The entries in this table are dynamically added and removed as a result of ARP requests and ARP replies. ARP requests and ARP replies are specific packets which are distributed through the network as a result of implementation of the protocol. The ARP protocol is implemented within the network equipment element by a device known as an ARP module. The ARP module may be software executing upon a processor within the network equipment element, or may be implemented on task specific hardware as in, for example an ASIC, or via a combination of software and hardware. Likewise, the network equipment element will also contain a mechanism for processing Internet Protocol data packets, an IP module, which may be software executing upon a processor within the network equipment element, or may be implemented on task specific hardware as in, for example an ASIC, or via a combination of software and hardware.

The following steps result in the generation of an ARP request packet:

1. The IP module sends a packet, destined for another host in the network to the ARP module.

2. The ARP module consults the ARP cache to resolve the IP address to the MAC address.

3. If the supplied IP address is present in the ARP cache, it is resolved into the required MAC address, and the resolved MAC address and packet are forwarded to the Ethernet driver for transmission onto the network.

4. If the supplied IP address is not present in the ARP cache, then the ARP module sends an ARP request packet to the Ethernet driver for transmission as a broadcast packet onto the network.

The ARP request packet is received and processed by all hosts on the network as it is a broadcast packet. The following steps are carried out when an ARP request packet is received by a host:

1. If the IP address specified in the request packet is for this host, then the ARP module of this host sends an ARP reply packet with this host's MAC address.

2. If the IP address specified in the request packet is for this host, then the ARP module of this host updates it ARP cache with the source MAC address to source IP address mapping present in the received ARP request packet. If the entry is already present in the cache it is overwritten at this point, automatically providing an update. If the entry is not present in the cache, it is added.

3. If the IP address specified in the request packet is not for this host, then the ARP module of this host discards the ARP request packet.

The ARP reply packet is directed to the host which transmitted the ARP request packet. When this host receives the ARP reply packet, it updates its ARP cache with the received mapping.

In general, an entry in an ARP cache is removed after a pre-determined timeout period, for example 20 minutes. This ensures that the ARP cache is not filled with unused or stale entries.

As previously mentioned, Label Distribution Protocol (LDP) is a protocol which may be used for the distribution of label binding information to Label Switched Routers in an MPLS network. Under the protocol, Advertisement Messages are used to create, change, and delete label mappings for Forward Equivalency Classes (FEC).

As the Advertisement Messages are sent to neighbors that are identified by IP addresses, all recipients of the advertisements may be found in the ARP database.

According to an embodiment of the invention, the ARP database may be augmented to include a list of labels that were advertised to that neighbor, for each entry in the ARP database.

Implementing this augmentation to the ARP database, and using the ARP entries as the basis for label binding information results in the automatic enabling and disabling of MPLS stations, and yields labels only on the appropriate port and MPLS station as reflected in what has been advertised by the Label Distribution Protocol to the network equipment element's neighbours.

In the event that a label is unresolved, i.e. cannot be found, when the ARP is consulted, the label is to be allowed on ALL ports. This transitory situation will be resolved by the normal operation of the LDP advertising operation cycle as the ARP database is resolved for any neighbours to which the labels are advertised.

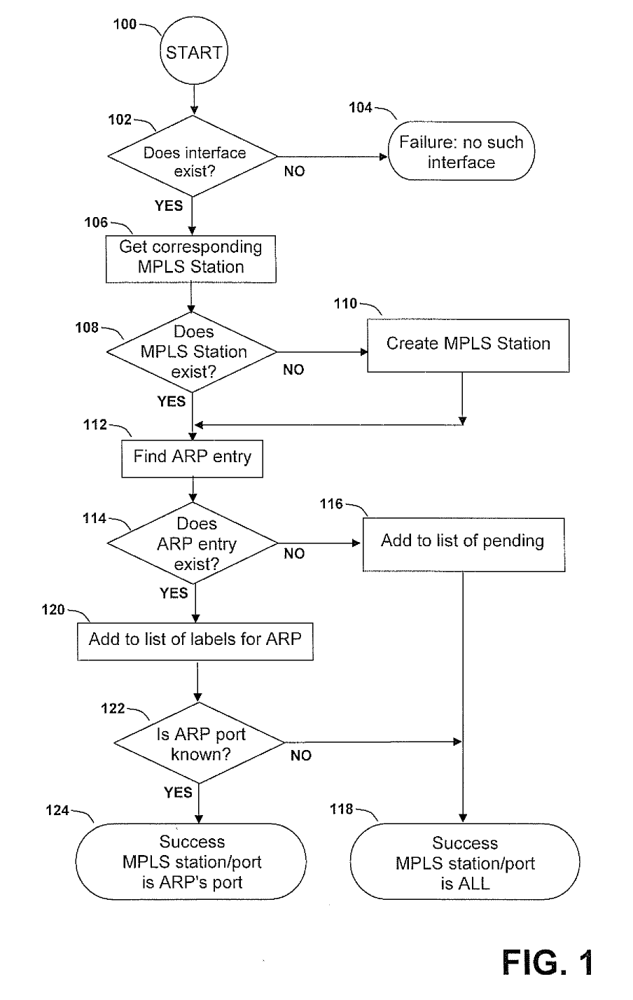

Referring to FIG. 1 there may be seen a flowchart depicting a method by which a label may be added to an ARP database.

The method commences at 100 with the intent of adding a label to the ARP database for IP interfaces with local route matching.

At 102 the database is queried as to the existence of the IP interface. If no such interface exists, the method indicates a Failure condition at 104.

If the IP interface is found, the corresponding MPLS station i.e. the MAC address, is sought at 106, and at 108 the database is queried as to the existence of the MPLS station in the entries. If no such MPLS station can be found, an MPLS station is created in the database at 110.

At 112 the ARP entry is sought. At 114 the database is queried as to the existence of an ARP entry. If no such entry can be found, the ARP entry is added to a list of pending ARP entries at 116, and at 118 success is indicated with the MPLS station associated and the port designation indicated as “ALL”. (Subsequent LDP protocol cycles will update this “ALL” designation, changing the pending ARP entry into an actual ARP entry with associated labels.)

If the ARP entry is found, at 120 the label is added to the list of labels in the ARP database.

At 122 the ARP database is queried as to whether the associated port is known. If no such associated port can be found, at 118 success is indicated with the MPLS station associated and the port designation indicated as “ALL”. (Subsequent LDP protocol cycles will update this “ALL” designation.)

If the ARP port is known, at 124 success is indicated with the MPLS station associated and the port designation indicated as the port provided by the ARP database.

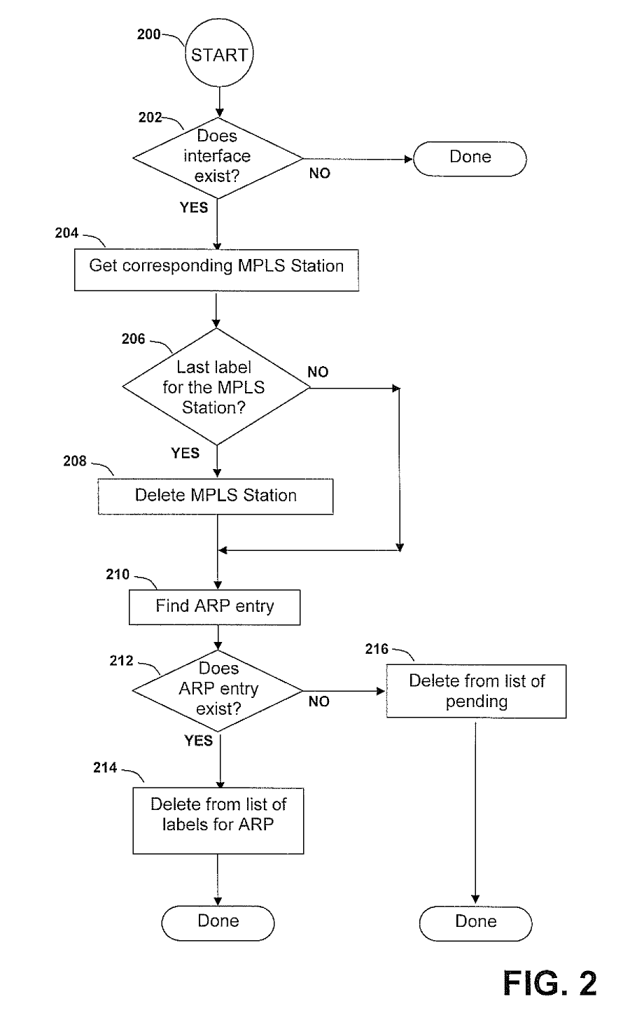

Referring to FIG. 2 there may be seen a flowchart depicting a method by which a label may be deleted from an ARP database.

The method commences at 200 with the intent of deleting a label from the ARP database for IP interfaces with local route matching.

At 202 the database is queried as to the existence of the IP interface. If no such interface exists, the method is done.

If the IP interface is found, the corresponding MPLS station is sought at 204, and at 206 the database is queried as to whether the provided label intended for deletion is the last label for the MPLS station. If it is, then the MPLS station is deleted from the database at 208.

If the label provided for deletion is not the last label for the MPLS station, then the associated ARP entry is sought at 210.

At 212 the database is queried as to the existence of an ARP entry. If no such entry can be found, the ARP entry is deleted from the list of pending ARP entries at 216, and the method is done.

If the ARP entry is known, at 214 it is deleted from the list of labels for the ARP and the method is done.

Therefore, what has been disclosed is a method for dynamically enabling MPLS stations and ports using an augmented ARP database. The method takes into account the label advertising of Label Distribution Protocol to immediate neighbors as identified by IP addresses, and using the ARP database augments the database to include for each ARP entry, a list of labels which were advertised to that neighbour. The net result is an automatic enabling/disabling of MPLS stations, and an allowance of labels only on the appropriate port and MPLS station as reflected in what has been advertised by the Label Distribution Protocol to a network element's neighbours.

While the foregoing is directed to various embodiments of the present invention, other and further embodiments of the invention may be devised without departing from the basic scope thereof. As such, the appropriate scope of the invention is to be determined according to the claims, which follow.

What is claimed is:

1. A method executed upon a network equipment element for automatically associating MPLS labels to MPLS station addresses, said method comprising the steps of:
establishing a database according to Address Resolution Protocol to associate network layer protocol addresses to data link layer addresses;
advertising label binding information according to Label Distribution Protocol;
augmenting said database to associate said labels to appropriate network layer protocol addresses; and processing received MPLS packets using said augmented database.

2. A method as claimed in claim 1 wherein
said processing step includes abandoning MPLS packets which are not associated to appropriate network layer protocol addresses.

3. A method as claimed in claim 1 wherein
said augmentation step includes a list of labels advertised to a neighbour host.

4. A method as claimed in claim 1 wherein
network layer protocol addresses comprises an Internet Protocol address.

5. A method as claimed in claim 1 wherein
data link layer addresses comprise an Ethernet Media Access Control address.

6. A method as claimed in claim 1 wherein
said network equipment element comprises a Label Switched Router.

7. A method as claimed in claim 1 wherein
said network equipment element comprises a Label Edge Router.

8. An article of manufacture for use in programming a network equipment element to augment an ARP database by associating MPLS labels to appropriate network layer protocol addresses, the article of manufacture comprising computer useable media accessible to the network equipment element, wherein the computer useable media includes at least one computer program that is capable of causing the network equipment element to perform the steps of:
establishing a database according to Address Resolution Protocol to associate network layer protocol addresses to data link layer addresses;
advertising label binding information according to Label Distribution Protocol;
augmenting said database to associate said labels to appropriate network layer protocol addresses; and
processing received MPLS packets using said augmented database.

9. An article of manufacture as claimed in claim 8 wherein
the network equipment element comprises a Label Switched Router.

10. An article of manufacture as claimed in claim 8 wherein
the network equipment element comprises a Label Edge Router.

11. An article of manufacture as claimed in claim 8 wherein
network layer protocol addresses comprises an Internet Protocol address.

12. An article of manufacture as claimed in claim 8 wherein
data link layer addresses comprise an Ethernet Media Access Control address.
